(19) United States
(12) Patent Application Publication
(10) Pub. No.: US 2003/0136157 A1
(43) Pub. Date: Jul. 24, 2003

(54) Cooling unit with sealing cap for high speed drawing in optical fiber drawing process

(76) Inventors: Hyun-Ju Lee, Chilgok-gun (KR); Ki-Tae Jung, Kumi-shi (KR)

Correspondence Address: CHA & REITER, 411 HACKENSACK AVE, 9TH FLOOR, HACKENSACK, NJ, 07601, US

(21) Appl. No.: 10/331,314

(22) Filed: Dec. 30, 2002

(30) Foreign Application Priority Data
Jan. 19, 2002 (KR) 2002-3206

(51) Int. Cl. C03B 37/10

(52) U.S. Cl. 65/513

(57) ABSTRACT

What is disclosed is a cooling unit with a sealing cap, for high speed optical fiber drawing in an optical fiber drawing process. The cooling unit includes: a cooling body through which the optical fiber drawn in high speed passes and in which heat exchange is performed by provided helium gas; and a sealing cap mounted on upper and lower ends of the cooling body, wherein at least more than one supplying member of ring type are provided in an inside of the sealing cap more than one time along progress direction of the optical fiber, for providing flow rate of reverse direction opposite to external air introduced along the drawing optical fiber so that the influence of the external air is minimized.

### CLAIM OF PRIORITY

This application claims priority to an application entitled “Cooling Unit with Sealing Cap for High Speed Drawing in Optical Fiber Drawing Process,” filed in the Korean Industrial Property Office on Jan. 19, 2002 and assigned Ser. No. 02-3206, the contents of which are hereby incorporated by reference.

### BACKGROUND OF THE INVENTION

1. Field of the Invention

The present invention relates to drawing equipment for use with an optical fiber drawing process. In particular, a process for drawing a strip of the optical fiber from a prepared optical fiber preform and to a cooling unit for high speed drawing.

2. Description of the Related Art

Generally, a process for fabricating the optical fiber is divided into (1) a process for manufacturing the optical fiber preform, and (2) an optical fiber drawing process. The drawing process includes drawing a strip of the optical fiber, which has a width thinner than a human hair, from the manufactured optical fiber preform.

In order to draw as much optical fiber as possible from one single optical fiber preform in the optical fiber preform manufacturing process, a study is being conducted, on a manufacturing process for the optical fiber preform of a large diameter. In particular, to manufacture the optical fiber preform of a large diameter, processes such as overjacketing tube or rod in tube are also applied. In order to resolve the foregoing concerns, a manufacturer needs to make a sizeble effort during the manufacturing the optical fiber preform of a large diameter or of manufacturing more stable optical fiber drawing equipment.

FIG. 1 schematically illustrates the optical fiber drawing process of a related art in which drawing equipment is mounted in a process order on a drawing tower. As shown in FIG. 1, the optical fiber drawing process of a related art, the equipment is configured vertically in sequence according to the processing order on a single drawing tower (more than 10 meters). Around the central axis of the drawing tower, the prepared optical fiber preform P is melted to a sufficient temperature (about more than 2000 degree) at a melting furnace 8 and drawn in form of a strip of the optical fiber F1. The diameter of the drawn optical fiber F1 is controlled by a diameter controller 9, and the fiber goes through a cooling unit 10 and is cooled to a suitable temperature, before the optical fiber is coated. The cooled optical fiber F2 goes through a coater 16. Thereafter, the optical fiber undergoes a plurality of ultraviolet hardening units 18 and the coated ultraviolet polymer is hardened.

Subsequently, the optical fiber F3 is processed by the hardening units 18, a capstan 19 and a plurality of rollers 22 and 24, and then is wound at a winder 26. The capstan 19 provides a predetermined tension to the optical fiber preform so that an optical fiber of a constant diameter is drawn. This series of drawing equipment is mounted in the processing order on the stand type drawing tower. Reference numeral 26a is a reel or spool on which the optical fiber is wound.

The optical fiber drawing equipment mounted on a optical fiber drawing tower should maintain precise horizontal and vertical status with respect to all elements constituting the equipment as well as the whole basic frame. In addition, it should have a structure insensitive to vibration or impulse. Particularly, the cooling unit should uniformly cool the drawing optical fiber.

The vertical height of the drawing tower shown in FIG. 1, is about more than 10 meters and the optical fiber drawn from one single optical fiber preform occupies vertical interval of about 10 meters. As the optical fiber is drawn in high temperature and speed, the cooling unit should cool the drawn optical fiber down to about 40 degrees. FIG. 2 illustrates the structure of a cooling unit for performing such cooling function according to an embodiment of a related art. As shown in FIG. 2, the optical fiber F1 is drawn in high temperature (1500 degree) and high speed (1800 mpm), and goes through the cooling unit to form the optical fiber F2 that is suitable for coating. The cooling unit includes a cooling body 10 and iris 12 and 14 mounted on upper and lower ends of the cooling body 10, respectively. The iris 12 and 14 prevent inflow of external air and fine movement of the optical fiber F1 and F2 upon initial drawing.

The cooling body 10 includes copper pipes that are multiply overlapped, i.e., a second copper pipe 112 is positioned within a first copper pipe 110 around the same axle. In the meantime, in the upper and lower ends of the cooling body 10, helium gas(He) is provided to (direction of arrow (1)) the inside 101 of the second pipe so that a helium gas atmosphere is formed in the inside 101 of the second pipe through which the drawn optical fiber passes. Also, cooling water 102 with a low temperature is provided between the first pipe 110 and the second pipe 112, and circulates in the direction of arrow (2), which cools the helium gas within the second copper. The cooling water 102 exchanges heat with the drawn optical fiber F1 having a high temperature. Due to the mutual heat exchange between the cooling water and the optical fiber, the drawn optical fiber F1 of high temperature is cooled down to a suitable temperature. In order to draw as much optical fiber as possible from a single prepared optical fiber preform, it is required to draw the optical fiber at high speed so that process efficiency is improved.

However, if the optical fiber is drawn from a prepared single optical fiber preform with a large diameter, external air penetrates into the inside of the second cooper pipe 112 through the upper iris 12, in which the helium gas atmosphere is formed. Due to the flow rate generated in the portion closest to the outer periphery of the optical fiber as the optical fiber is drawn in high speed, the helium gas density within the second copper pipe is lowered. In particular, the helium gas density of the portion closest to the upper iris 12 among the cooling body 10 is lowered. This lowering of helium gas density is the most important factor contributing to lower cooling efficiency. In addition, causes a problem in which more helium gas should be provided to the cooling unit in order to supplement the lowered helium gas density. Consequently, the manufacturer provides more helium gas in order to resolve deterioration in cooling efficiency generated due to lower helium gas density, which in turn raises manufacturing costs.

### SUMMARY OF THE INVENTION

The present invention reduces or overcomes many of the above problems and disadvantages, and one object of the present invention is to solve the foregoing problems by providing a cooling unit for high speed drawing in the optical fiber drawing process.

Another object of the present invention, is to provide a cooling unit for high speed drawing capable of improving efficiency of the optical fiber drawing process.

In accordance with principals of the present invention a cooling unit is provided for cooling an optical fiber drawn from an optical fiber drawing process, the cooling unit includes: a cooling body through which the optical fiber drawn in high speed passes and in which heat exchange is performed using helium gas; and a sealing cap mounted on upper and lower ends of the cooling body, wherein at least more than one supplying member of ring type are provided in an inside of the sealing cap and in more than one position along progress direction of the optical fiber, wherein the supplying member are configured for providing a flow rate of reverse direction opposite to external air introduced along the drawing optical fiber so that the influence of the external air is minimized.

### BRIEF DESCRIPTION OF THE DRAWINGS

The invention will be described in detail with reference to the following drawing in which like reference numerals refer to like elements in which:

FIG. 1 is a structural view schematically illustrating drawing equipment for an optical fiber drawing process of a related art;

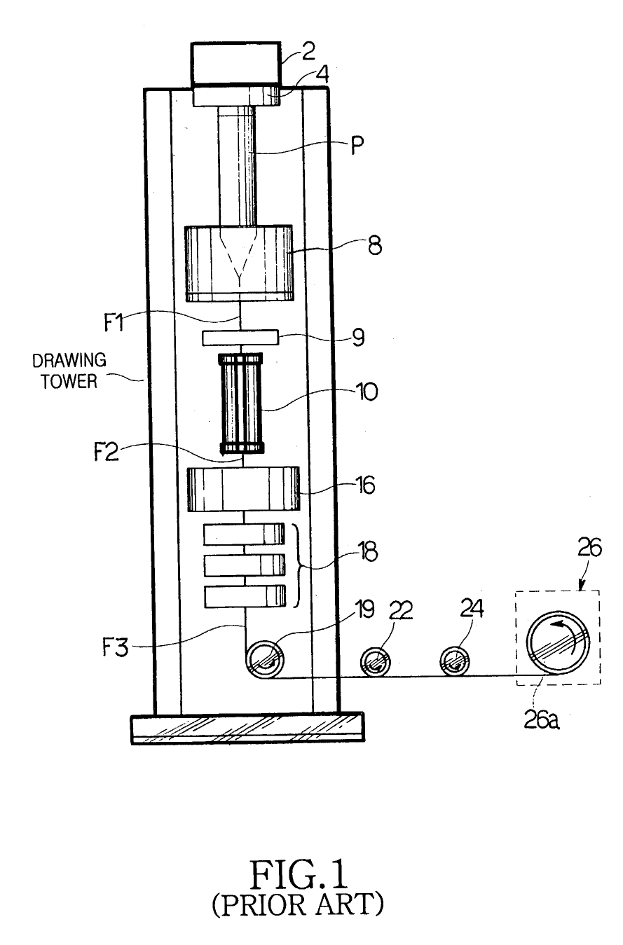

FIG. 2 is a front view illustrating a cross-section of a portion of a cooling body in a cooling unit according to an embodiment of a related art;

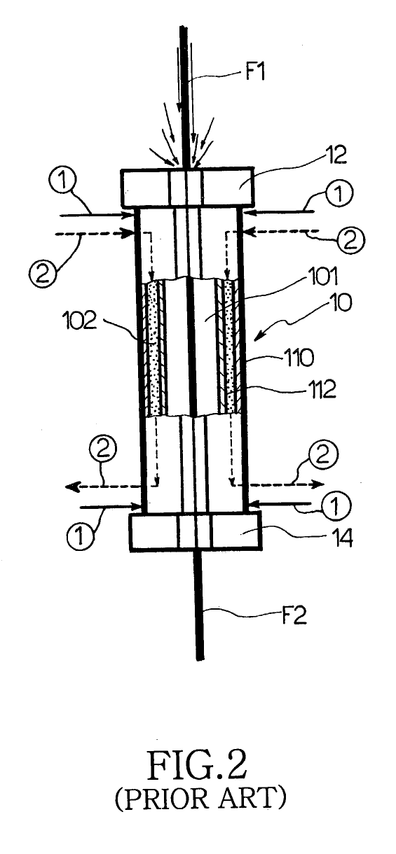

FIG. 3 is a cross-sectional view of an upper portion of a cooling unit with sealing cap according to a preferred embodiment of the present invention;

FIG. 4 is a cross-sectional view illustrating a status before operation of the cooling unit shown in FIG. 3;

FIG. 5 is a graph illustrating a relation between helium gas supplying position of a cooling unit with a sealing cap according to the present invention and air content on a surface of an optical fiber according to helium gas amount;

FIG. 6 is a graph illustrating temperature efficiency (cooling efficiency) on a surface of an optical fiber according to helium gas amount in a cooling unit with a sealing cap according to the present invention; and

FIG. 7 is a drawing illustrating a flow line for helium gas and discharging flow line for the introduced air.

### DETAILED DESCRIPTION OF THE PREFERRED EMBODIMENT

In the following description of the present invention, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. Moreover, it will be recognized that certain aspects of the figures are simplified for explanation purposes and that the full system environment for the invention will comprise many known functions and configurations all of which need not be shown here. In the drawings, the same or similar elements are denoted by the same reference numerals even though they are depicted in different drawings.

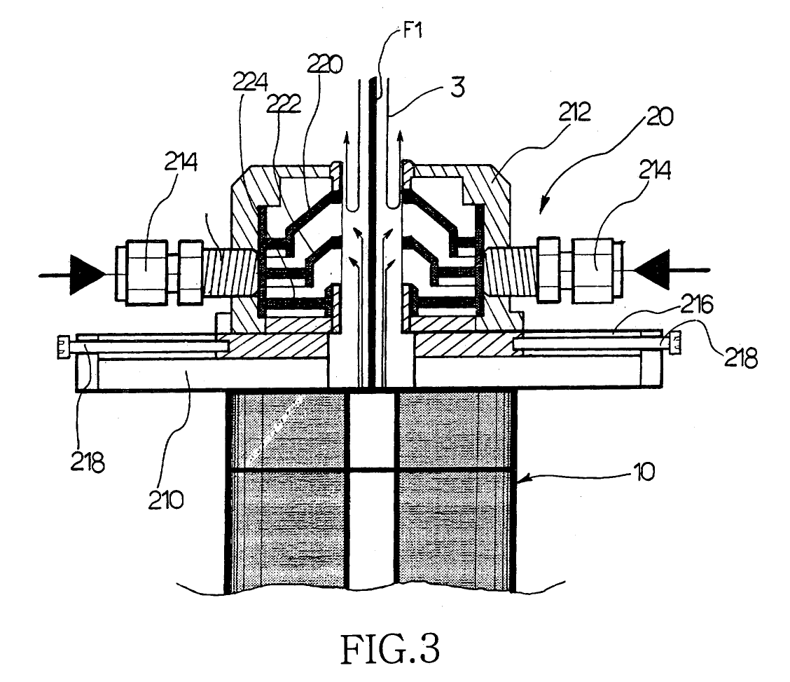

FIG. 3 is a cross-sectional view illustrating a construction of a cooling unit provided with a sealing cap according to the present invention, to an upper end of a cooling body 10. As shown in FIG. 3, the cooling unit according to the present invention, includes the cooling body 10 extended in lengthwise direction, through which the optical fiber F1 passes, and the sealing cap 20 mounted on the cooling body 10, for isolating the drawn optical fiber from the outside environment. In the illustrative embodiment of FIG. 3, the sealing cap 20 is mounted on the upper end of the cooling body. Alternatively, the sealing cap 20 could be mounted on a lower end.

The optical fiber F1 of high temperature drawn in high speed, goes through the sealing cap 20 and the cooling body 10, and is cooled down to a appropriate temperature. The construction of the sealing cap 20, according to the present invention helpful in performing such cooling function, is described below.

The sealing cap 20 includes a basic supporting board 210, a sealing body 212 configured such that it encloses the basic supporting board 210, and more than one gas supplying unit 214 mounted on the sealing body 212, for providing gas. Preferably, the sealing cap 20 is formed in pairs, which allows the possibility of it to being applied to the cooling unit for the optical fiber and attaching and detaching to and from the drawing tower. The gas provided into the inside of the sealing body 212 is helium gas through the gas supplying unit 214. At least more than one gas supplying units are provided in the outer peripheral direction, with a constant interval along the sealing body. Although three gas supplying units are provided for the present invention, only two gas supplying unit are shown in FIG. 3.

The helium gas, introduced through the helium gas supplying unit 214, fills a space in which the drawn optical fiber F1 exists with helium gas atmosphere by means of supplying members 220, 222, and 224. The supplying members 220, 222, and 224 are of a ring type and provided within the sealing body 212, and in different positions along the progress direction of the optical fiber. The supplying members 220, 222 and 224, simultaneously, provide a flow rate of reverse direction (the direction of arrow (3)) for preventing inflow of external air generated upon high speed drawing. Also, the supplying members are connected to the gas supplying unit so that helium gas passes through the supplying member and reaches the drawn optical fiber.

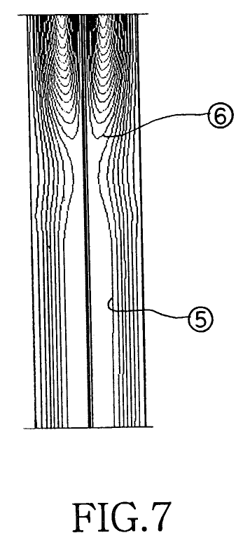

FIG. 7 illustrates the flow line for the helium gas and discharging flow line for the introduced air. Reference numeral (5) stands for the flow line of helium gas, and reference numeral (6) stands for the discharging flow line for the introduced air. A gas supplying fastening member 214a is provided to the gas supplying unit 214 and mounted on an appropriate position of a couple of sealing body 212. The gas supplying unit 214 can be attached and detached to and from the sealing body 212 by means of the gas supplying fastening member 214a.

As described above, the supplying members 220, 222, and 224 for providing direction to the helium gas coming in through the gas supplying unit 214, is installed in the inside of the sealing cap 20. Moreover, the supplying members are configured such that they are preferably stacked along the drawn optical fiber F1 and are of a ring type so that the gas is uniformly provided with respect to the drawn optical fiber F1. The supplying members are provided along the inner wall of the sealing body 212 in order to prevent air from inflowing into the inside of the sealing cap 20 along the periphery of the optical fiber upon high speed drawing of the optical fiber. The supplying members are installed at a predetermined angle for providing directions to the helium gas.

Fluid generated in the high speed drawing passes through an opening of the sealing cap 20 having a flow rate toward the inside, and simultaneously, fluid resistance against the flow rate is generated. Such fluid resistance provides force in the opposite direction by the helium gas introduced from the lower portion. This phenomenon maintains the helium gas density within the cooling body 10 at almost 100%. If the helium gas density within the cooling body 10 is maintained heat transfer, between the drawn optical fiber of high temperature and the helium gas, is proceeded actively so that the cooling efficiency is maximized.

Additionally, a sliding guide 216 and a sliding handle 218 are provided so that attachment and detachment of cooling unit to and from the optical fiber drawing equipments is easier. Also, for workability the sealing cap 20 consists of two symmetric sealing bodies 212 with a Teflon core or inside.

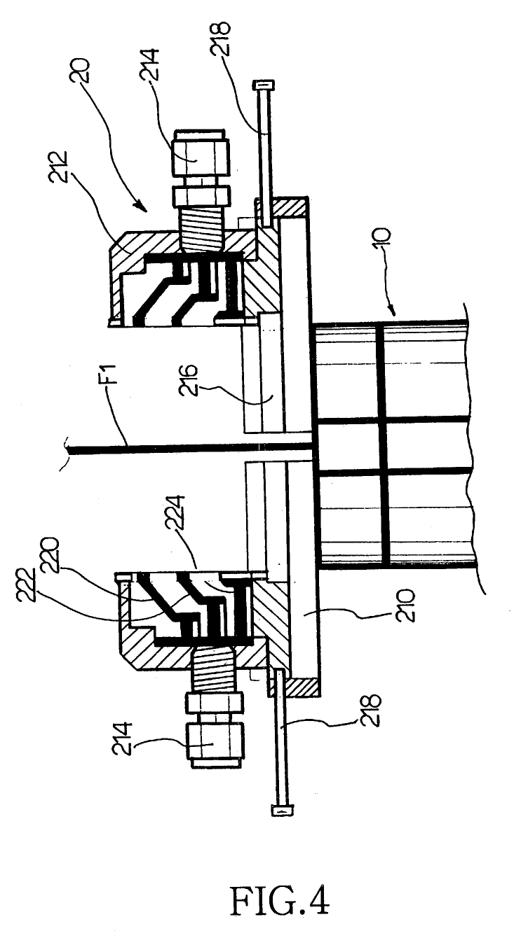

As shown in FIG. 4, when the sealing cap is not in operation, a couple of the sealing cap 20 is separated in order for swift preparation of the optical fiber. This is performed in the following manner, an operator loosens the fasten and separates the sealing cap by pulling the sliding handle in outward direction. The separating is performed because the sealing does not need to be used when the optical fiber is drawn from the optical fiber preform in low speed (300 mpm).

As shown in FIG. 3, when the sealing cap 20 is in operation, namely, when the speed in which the optical fiber is drawn from the optical fiber preform is more than 300 mpm, the sealing cap 20 is pulled in the inward direction by the sliding handle 218 and stuck accordingly. After alignment of the sealing cap 26 is checked, the helium gas is provided through the helium gas supplying unit 214, whereby the cooling function for the high speed optical fiber drawing process is performed.

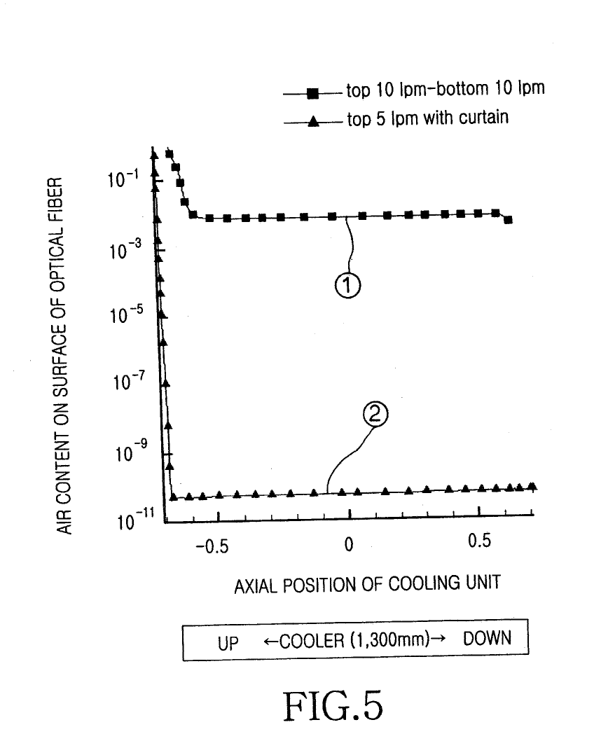

FIG. 5 is a graph illustrating a relation between helium gas supplying position of the cooling unit, to which the sealing cap of the present invention is applied, and air content on the surface of the optical fiber according to helium gas amount. As shown in FIG. 5, reference numeral (1) stands for air content on the surface of the optical fiber the sealing cap is not in use. Reference numeral (2) stands for air content on the surface of the optical fiber when the sealing cap is in use. Moreover, reference numeral (1) stands for the case that gas injecting positions are provided equally on the upper and the lower ends, respectively, with 10 lpm (liter per minute) injected on the upper end, 10 lpm injected on the lower end. Accordingly, about 60 lpm of the helium gas in total is injected, presuming that three gas injecting members of the cooling unit are provided on the upper and the lower ends, respectively.

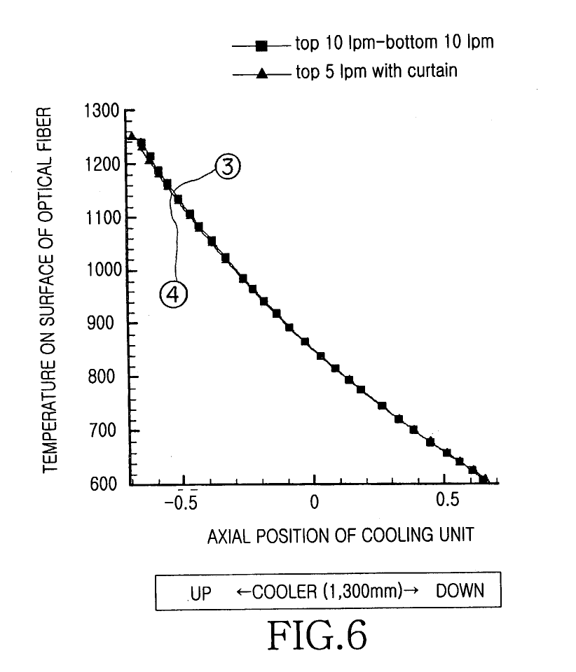

However, about 15 lpm in total is injected, as represented by the reference numeral (2), if 5 lpm is injected at the sealing cap provided on the upper end, i.e., presuming that three gas injecting members are provided to the cooling unit. As is apparent from FIG. 6, air content on the surface of the optical fiber in case of the reference numeral (2) is very small compared with the related art.

FIG. 6 is a graph illustrating temperature efficiency (cooling efficiency), in a cooling unit with the sealing cap according to the present invention, on a surface of the optical fiber according to helium gas amount. As shown in FIG. 6, the cooling efficiencies of a related art and the present invention are somewhat similar (reference numeral (3) represents the cooling efficiency of a prior art cooling unit with the related art adopted reference numeral (4) represents the cooling efficiency of a cooling unit with the present invention) Advantageously, 60 lpm is needed for the cooling unit of a related art, but according the present invention, only 15 lpm of the helium gas could achieve the same cooling efficiency. Thus, the cooling unit according to the present invention, could achieve the same cooling efficiency and importantly saving as much as 75% of the helium gas.

As described above, when the optical fiber is drawn in high speed the present invention operates the sealing cap, thereby maintaining the constant helium gas density economically. Therefore, the present invention enables a savings of about more that 50% of the helium gas amount for the cooling unit.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structure.

What is claimed is:

1. A cooling unit for use in cooling an optical fiber drawn from an optical fiber drawing process, the cooling unit comprising:
a cooling body through which the optical fiber is drawn in high speed passes and in which heat exchange is performed by using helium gas; and
at least one sealing cap mounted on an end of the cooling body, wherein at least more than one supplying member is coupled to the sealing cap, and in more than one position along the progress direction of the optical fiber, wherein the supplying members are configured for providing a flow rate of reverse direction opposite to external air introduced along the drawing optical fiber so that influence of the external air is minimized.

2. The cooling unit according to claim 1, wherein the supplying member are a ring type.

3. The cooling unit according to claim 1, wherein the at least one sealing cap is mounted on opposite ends of the cooling body.

4. The cooling unit according to claim 3, wherein the at least one sealing cap is mounted on upper and lower ends of the cooling body.

5. The cooling unit according to claim 2, wherein the supplying members are coupled to the inside of the at least one sealing cap.

6. The cooling unit according to claim 2, wherein three supplying members of ring type are provided.

7. The cooling unit according to claim 1, wherein the supplying members of ring type are connected to a helium gas supplying unit.

8. The cooling unit according to claim 1, wherein the supplying members of ring type influence of the external air.

9. The cooling unit according to claim 1, wherein the supplying members of ring type are configured to minimize influence of the external air.

10. The cooling unit according to claim 1, wherein the supplying members of ring type are configured to prevent inflow of external air generated upon high speed drawing.

11. The cooling unit according to claim 1, wherein the supplying members of ring type are configured to such that they are stacked along the drawn optical fiber so that the helium gas is uniformly provided with respect to the drawn optical fiber.
